(19) United States
(12) Patent Application Publication
(10) Pub. No.: US 2007/0092630 A1
(43) Pub. Date: Apr. 26, 2007

(54) Cross-linkable soy protein compositions and emulsified meat products including the same

(76) Inventors: Harry Chu, Chesterfield, MO (US); Matthew K. McMindes, Chesterfield, MO (US)

Correspondence Address: SOLAE, LLC, PO BOX 88940, ST. LOUIS, MO, 63188, US

(21) Appl. No.: 11/257,181

(22) Filed: Oct. 24, 2005

(51) Int. Cl. A23L 1/31

(52) U.S. Cl. 426/641

(57) ABSTRACT

Cross-linkable soy protein compositions and emulsified meat products including cross-linked soy protein compositions prepared from the cross-linkable soy protein compositions are disclosed. Specifically, the cross-linkable soy protein compositions comprise a soy protein product and a cross-linking compound. Once cross-linked, the cross-linkable soy protein compositions form cross-linked soy protein compositions that are suitable for use in cooked emulsified meat products.

### BACKGROUND OF THE DISCLOSURE

The present disclosure generally relates to cross-linkable soy protein compositions that can be cross-linked to provide improved texture and cooked gel strength when used in emulsified meat products. The present disclosure also relates to emulsified meat products including the cross-linked soy protein compositions. More particularly, the present disclosure relates to cross-linkable soy protein compositions that include a soy protein product and a cross-linking compound. The cross-linkable soy protein compositions cross-link in situ to provide a firmer texture and an improved cooked gel strength when used in emulsified meat products such as when used in hot dogs.

In response to the results of recent research showing the negative effects of certain foods on health and nutrition, consumers are becoming more health conscious and monitoring their food intake more carefully. In particular, since animal products are the main dietary source of cholesterol and may contain high levels of saturated fats, health professionals have recommended that consumers significantly reduce their intake of red meats. As a substitute, many consumers are choosing soy products.

It is well known that vegetable products, such as soy protein products, contain no cholesterol. For decades, nutritional studies have indicated that the inclusion of soy protein in the diet actually reduces serum cholesterol levels in people who are at risk. Further, the higher the cholesterol level, the more effective soy proteins are in lowering that level. A number of foods and drink products available today utilize soy protein products including, for example, dry blended beverages, ready to drink beverages that are of neutral or acidic pH, yogurt, food and protein bars, infant formula, emulsified meat products, and whole muscle meat products.

Suitable soy protein materials for use in foods and drink products include soy flakes, soy flour, soy grits, soy meal, soy protein concentrates, soy protein isolates, and mixtures thereof. The primary difference between these soy protein materials is the degree of refinement relative to whole soybeans.

Soy flakes are generally produced by dehulling, defatting, and grinding the soybean and typically contain less than 65% (by weight) soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the material and to avoid costs involved in the addition and removal of water from the soy material. The resulting ground, heat treated material is a soy flour, soy grit, or a soy meal, depending on the average particle size of the material. Soy flour generally has a particle size of less than about 150 μm. Soy grits generally have a particle size of about 150 to about 1000 μm. Soy meal generally has a particle size of greater than about 1000 μm.

Soy protein concentrates typically contain from about 65% (by weight) to less than 90% (by weight) soy protein on a moisture-free basis, with the major non-protein component being fiber. Soy protein concentrates are typically formed from defatted soy flakes by washing the flakes with either an aqueous alcohol solution or an acidic aqueous solution to remove the soluble carbohydrates from the protein and fiber. After extracting the soy protein and fiber from the soluble carbohydrates, the pH of the extract is raised using an alkaline agent and then the extract is dried to make a soy protein concentrate.

Soy protein isolates, which are more highly refined soy protein materials, are processed to contain at least 90% (by weight) soy protein on a moisture-free basis and little or no soluble carbohydrates or fiber. Soy protein isolates are typically formed by extracting soy protein and water soluble carbohydrates from defatted soy flakes or soy flour with an alkaline aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein to precipitate the protein from the extract. The precipitated protein is separated from the extract, which retains the soluble carbohydrates, the pH of the protein is raised by contacting the protein with an alkaline agent, and the protein is dried.

Soy protein concentrates and soy protein isolates are particularly effective functional food ingredients due to the versatility of soy protein and the relatively high content thereof in soy protein concentrates and isolates. Additionally, the lack of raffinose and stachyose oligosaccharides, which naturally occur in soybeans, is advantageous. Humans lack the α-galactosidase enzyme needed to break down and digest complex oligosaccharides such as raffinose and stachyose into simple carbohydrates such as glucose, fructose, and sucrose, which can be easily absorbed by the gut. Instead of being absorbed, soy raffinose and stachyose enter the lower intestine where they are fermented by bacteria to cause intestinal gas and flatus.

Despite all of the above advantages that soy proteins provide, it is well known that by supplementing foods with increased levels of dietary fiber and soy protein, texture can be seriously compromised. This is especially true for emulsified meat products. It has been discovered that emulsified meat products supplemented with soy protein have an unpleasant soft texture. Instead of improving texture, current attempts to solve textural problems merely hide the textural characteristics. Consequently, these “fixes” are only temporary, as shortly after the initial bite or product breakdown, the true nature of the product's texture becomes apparent. While the loss of textural quality is appreciated by those skilled in the art, the complex interactions that give rise to poor textures are little understood.

As such, a need exists in the industry for a soy protein composition capable of providing improved texture when used in emulsified meat products. Additionally, it would be advantageous if the soy protein compositions had improved cooked gel strength when used in the emulsified meat products.

### SUMMARY OF THE DISCLOSURE

Generally, the present disclosure provides for cross-linkable soy protein compositions comprising a soy protein product and a cross-linking compound. Specifically, the soy protein products are cross-linked by the cross-linking compound when subjected to suitable conditions, such as, for example, heat and moisture, to produce a cross-linked soy protein composition. These cross-linked soy protein compositions provide for an improved texture and cooked gel strength when used to supplement food products such as emulsified meat products. In one embodiment, the soy protein product for cross-linking in the cross-linkable soy protein composition is a soy protein isolate. In another embodiment, the soy protein product for cross-linking in the cross-linkable soy protein composition is a soy protein concentrate. The present disclosure also sets forth processes for making soy protein product compositions, and meat products including the soy protein compositions.

As such, in one embodiment, the present disclosure is directed to a cross-linkable soy protein composition for use in an emulsified meat product. The cross-linkable soy protein composition comprises a soy protein product and a cross-linking compound. The cross-linking compound comprises at least about 10% (by total mass cross-linking compound) aldehyde.

The present disclosure is further directed to a cooked emulsified meat product comprising a processed meat and a cross-linked soy protein composition. The cross-linked soy protein composition is prepared from a cross-linkable soy protein composition comprising a soy protein product and a cross-linking compound. The cross-linking compound comprises at least about 10% (by total mass cross-linking compound) aldehyde.

The present disclosure is further directed to a process of producing a cooked emulsified meat product. The product comprises providing a soy protein product; mixing the soy protein product with a cross-linking compound to form a cross-linkable soy protein composition, wherein the cross-linking compound comprises at least about 10% (by total mass cross-linking compound) aldehyde; mixing the cross-linkable soy protein composition with a processed meat; and steam cooking the mixture of cross-linkable soy protein composition and processed meat to form a cooked emulsified meat product.

Other features and advantages of this disclosure will be in part apparent and in part pointed out hereinafter.

### DETAILED DESCRIPTION OF THE DISCLOSURE

The present disclosure is generally directed to a cross-linkable soy protein composition comprising a soy protein product and a cross-linking compound. The cross-linking compound comprises at least about 10% (by total mass cross-linking compound) aldehyde. Specifically, once cross-linked, the cross-linkable soy protein compositions form cross-linked soy protein compositions, which can provide improved texture and cooked gel strength when used in emulsified meat products.

As noted above, the cross-linkable soy protein compositions comprise a soy protein product and a cross-linking compound. In one embodiment, the soy protein product is a soy protein isolate. A soy protein isolate suitable for use in the cross-linkable soy protein composition can be obtained by processing a soy protein source, such as soy flakes, by an extraction process using an aqueous alkaline wash. Extraction processes for forming soy protein isolates are well known and disclosed, for example, in U.S. Pat. No. 6,313,273, issued to Thomas, et al., (Nov. 6, 2001) and U.S. Pat. No. 6,830,773, issued to Porter, et al. (Dec. 14, 2004).

One process suitable for preparing a soy protein isolate described herein includes cracking soybeans to remove the hull, rolling them into flakes with flaking machines, defatting the flakes with hexane or heptane, subjecting the flakes to an aqueous extraction process, suspending the extracted soy protein in a wash solution, and precipitating a soy protein curd therefrom. Suitable flaking machines may consist of a pair of horizontal counter-rotating smooth steel rolls. The rolls are pressed one against the other by means of heavy springs or by controlled hydraulic systems. The soybeans are fed between the rolls and are flattened as the rolls rotate one against the other. The roll-to-roll pressure can be regulated to determine the average thickness of the flakes. The rolling process disrupts the oil cell, facilitating solvent extraction (i.e., hexane or heptane) of the oil. Specifically, flaking increases the contact surface between the oilseed tissues and the extractant, and reduces the distance that the extractant and the extract will have to travel in the extraction process as described herein below. Typical values for flake thickness are in the range of 0.2 to 0.35 millimeters.

The defatted soy flake material may then be put through an aqueous extraction process. Typically, the aqueous extraction process is an aqueous alkaline wash. The aqueous alkaline wash removes materials soluble therein, including a substantial portion of the isoflavones and carbohydrates. This produces a protein material that contains at least 90% protein by weight on a moisture-free basis, but which is significantly reduced in isoflavone concentration.

Typically, the alkaline wash has a pH of from 8.5 to about 10. The extraction is generally conducted by contacting the defatted soy flakes with an aqueous solution containing a set amount of base, such as sodium hydroxide, potassium hydroxide, ammonium hydroxide, and/or calcium hydroxide, and allowing the pH to slowly decrease as the base is neutralized by substances extracted out of the solid soy flakes. The initial amount of base is typically chosen so that at the end of the extraction operation the extract has a desired pH value, e.g., a pH within the range of from 8.5 to about 9.5. Alternatively, the pH of the aqueous phase can be monitored (continuously or at periodic time intervals) during the extraction and base can be added as needed to maintain the pH at a desired value.

Desirably, the aqueous alkaline wash should be a food grade reagent. The defatted soy flake material should be contacted with sufficient wash solution to form a soy protein extract. The weight ratio of wash solution to defatted soy flake material may be from about 2:1 to about 20:1, and preferably is from about 5:1 to about 10:1. Preferably, the defatted soy flake material is agitated in the wash solution and then centrifuged for a period of time to facilitate removal of materials soluble in the wash solution from the soy flake material. The wash solution is recirculated through the extractor until the residual oil content in the soy flakes is reduced to the desired level. The above described aqueous alkaline wash extraction removes water soluble components of the soy protein-containing material, such as carbohydrates and fat.

Once the soy protein has been extracted, it is suspended in a wash solution. Typically, the wash solution comprises water having a temperature of from about 90° F. to about 100° F. (32-38° C.). In a suitable embodiment, the extracted soy protein is suspended for 10 minutes at a temperature of 96° F. (35.6° C.). This water wash suspension further removes water soluble components of the extracted soy protein.

Finally, the suspended soy protein is precipitated with an acid to form a soy protein isolate. Precipitation separates remaining impurities, such as carbohydrates and fats, from the soy protein isolate. In one embodiment, to allow for sufficient precipitation, the acid is contacted with the suspended soy protein for a time period of about 5 minutes. Typically, the precipitation of the soy protein isolate is done at or near the isoelectric point of the soy proteins; that is, precipitation at a pH of from about 4.0 to about 5.0, preferably about 4.5. Suitable acids for precipitation can include, for example, hydrochloric acid, citric acid, phosphoric acid, and other organic and inorganic acids.

The above extraction, suspension, and precipitation steps can optionally be repeated one or more times to further remove impurities, such as carbohydrates and fat, from the soy protein isolate.

In order to impart the desired level of soy protein into the cross-linkable soy protein compositions described herein, suitable soy protein isolates comprise at least 90% (by weight on a moisture-free basis) soy protein, More suitably, the soy protein isolate comprises from 90% (by weight on a moisture-free basis) to about 95% (by weight on a moisture-free basis) soy protein.

In addition to the soy protein, the soy protein isolate generally comprises less than 2.0% (by weight) carbohydrates, from about 0.2% (by weight) to about 1.0% (by weight) fat, less than 5.0% (by weight) ash, and from about 3.0% (by weight) to about 6.0% (by weight) moisture.

Alternatively, a suitable commercially available soy protein isolate prepared by aqueous alkaline extraction can be used as the soy protein product. For example, one suitable soy protein isolate prepared is SUPRO® 500E, available from The Solae Company (St. Louis, Mo.). Other suitable commercially available soy protein isolates include SUPRO® EX32, available from The Solae Company (St. Louis, Mo.), and Profam® 974, available from Archer-Daniels Midland Company (Decatur, Ill.).

In another embodiment, the soy protein product for use in the cross-linkable soy protein composition of the present disclosure is a soy protein concentrate. One extraction process suitable for preparing a soy protein concentrate for use in the cross-linkable soy protein composition described herein includes obtaining a defatted soy flake material using the method discussed herein above. The defatted soy flake material may then be put through a solvent extraction process. Typically, the solvent for the extraction process is an aqueous acid or alcohol wash. The aqueous acid or alcohol wash removes materials soluble therein, including a substantial portion of the isoflavones and carbohydrates. This produces a protein concentrate material that contains from about 65% to about 90% protein by weight on a moisture-free basis, but which is significantly reduced in isoflavone concentration.

Alcohol extraction to remove alcohol soluble components from the protein is particularly preferred in the solvent extraction process since alcohol extraction generally produces a better tasting soy protein material compared to aqueous acid extraction. This type of extraction is based on the ability of the wash solvent solutions to extract the soluble sugar/carbohydrate fraction of the defatted soy flake without solubilizing its proteins. A suitable alcohol solvent is an aqueous solution of lower aliphatic alcohols, such as, methanol, ethanol, and isopropyl alcohol.

The alcohol wash typically used in the processes of the present disclosure is a neutral pH wash solution, that is, a wash solution having a pH less than 8.5 and more than about 6.0. Suitably, the aqueous wash is conducted at an as is pH of from about 6.5 to about 7.5.

Typically, the alcohol wash should be a food grade reagent, and preferably is an aqueous ethanol solution. An aqueous ethanol solution may contain from about 55% to about 90% ethanol by volume. The soy flake material should be contacted with sufficient wash solution to form a soy protein concentrate containing between about 65% and about 85% protein, by dry weight. Additionally, the resulting soy protein concentrate has a pH of about 7.0. The weight ratio of wash solution to soy flake material may be from about 2:1 to about 20:1, and preferably is from about 5:1 to about 10:1. Preferably, the soy flake material is agitated in the wash solution and then centrifuged for a period of time to facilitate removal of materials soluble in the wash solution from the soy flake material. The wash solution is then decanted from the soy flake material to provide the soy protein concentrate having a pH of about 7.0. The wash solution is recirculated through the extractor until the residual oil content in the soy flakes is reduced to the desired level. The above described alcohol wash extraction removes alcohol soluble components of the soy protein concentrate.

In order to impart the desired level of soy protein into the cross-linkable soy protein composition described herein, suitable soy protein concentrates comprise from about 65% (by weight on a moisture-free basis) to less than 90% (by weight on a moisture-free basis) soy protein. More suitably, the soy protein concentrate comprises about 70% (by weight on a moisture-free basis) soy protein.

In addition to the soy protein, the soy protein concentrate generally comprises from about 10% (by weight) to about 20% (by weight) carbohydrate, from about 0.5% (by weight) to about 2.0% (by weight) fat, from about 3.0% (by weight) to about 8.0% (by weight) ash, and from about 1.0% (by weight) to about 7% (by weight) moisture.

Alternatively, a suitable commercially available soy protein concentrate prepared by aqueous ethanol extraction can be used as the soy protein product. For example, suitable soy protein concentrates are Alpha® 12 and Procon® 2000, both available from The Solae Company (St. Louis, Mo.). Another suitable commercially available soy protein concentrate is Arcon® S, available from Archer Daniels Midland (Decatur, Ill.).

Suitably, the soy protein product is present in the cross-linkable soy protein composition in an amount of from about 90% (by weight) to about 99.5% (by weight). More suitably, the soy protein product is present in the cross-linkable soy protein composition in an amount of from about 90% (by weight) to about 98% (by weight), and even more suitably 95% (by weight) to about 97.5% (by weight).

In addition to the soy protein product, the cross-linkable soy protein composition comprises a cross-linking compound. One suitable cross-linking compound for use in the cross-linkable soy protein composition described herein is a smoke flavor compound, conventionally available in liquid or dry powder form. Typically, a smoke flavor compound is prepared from the pyrolysis of hardwood. Specifically, smoke, generated by the combustion and/or pyrolysis of hardwood, is collected, and, can be fed through a column counter current to a flow of recirculating water. Alternatively, some components can be condensed directly to form a liquid, then water is added to the condensed smoke components. Dilution of condensable smoke components with water by either method results in the separation of undesirable tars, polymers, and other water-insoluble components from the desirable liquid smoke components.

In the preparation of a smoke flavor compound, additional water-insoluble tars separate from the smoke flavor compound while the smoke flavor compound is held in storage. Water-insoluble hydrocarbons, such as polynuclear aromatic compounds, are unavoidable contaminants associated with the pyrolysis of wood, and settle out of the smoke flavor compound with the tar. The hydrocarbons, such as the tar, are physically separated from the smoke flavor compound. The water-insoluble tar and other undesirable products unsuitable for use in food, is then discarded.

One suitable smoke flavor compound is an aqueous smoke flavor compound, such as that described in U.S. Pat. No. 3,106,473, issued to Hollenbeck (Dec. 27, 1961), which is hereby incorporated by reference in its entirety. The aqueous smoke flavor compound can suitably be produced by partial combustion of hardwood sawdust with limited access to air, followed by collecting the desirable smoke constituents in water. Specifically, this type of smoke flavor compound is typically called a “slow pyrolysis” smoke flavor compound.

Another suitable smoke flavor compound is prepared as disclosed in U.S. Pat. No. 4,876,108, issued to Underwood, et al. (Oct. 24, 1989), which is hereby incorporated by reference in its entirety. Specifically, the smoke flavor compound, termed “fast pyrolysis” smoke flavor compound is produced by rapidly heating ground wood or cellulose in an oxygen-starved atmosphere, and collecting the water-soluble pyrolysis products. Like the “slow pyrolysis” smoke flavor compound, the tar, polymers, and hydrocarbons must be separated and discarded, leaving the water-soluble components.

Commercially available liquid smoke flavor compounds suitable for use as the cross-linking compounds described herein include, for example, Charsol Select 24-P and Charsol Supreme. Maillose Dry, and VSA Dry, sold in powdered form, are also suitable smoke flavor compounds for use as the cross-linking compounds. These smoke flavor compounds are all commercially available from Red Arrow International LLC, Manitowoc, Wis.

The water-soluble components of the smoke flavor compound generally are divided into classes based on compounds having distinct functional groups. These classes are acids, carbonyls, phenolics, and basic and neutral constituents. In general, phenolics are the primary flavoring compounds, carbonyls are the primary coloring compounds, and acids are primarily preservatives and pH controlling agents. Particularly preferred smoke flavor compounds for use as the cross-linking compounds described herein include a relatively high amount of carbonyls. A particularly preferred carbonyl is an aldehyde, such as hydroxyacetaldehyde, dialdehyde, and malonaldehyde.

Suitably, the cross-linking compound comprises at least about 10% (by total mass cross-linking compound) aldehyde. More suitably, the cross-linking compound comprises from about 10% (by total mass cross-linking compound) to about 20% (by total mass cross-linking compound) aldehyde, and even more suitably, from about 10% (by total mass cross-linking compound) to about 12% (by total mass cross-linking compound) aldehyde.

The cross-linkable soy protein composition comprises an amount of soy protein product to cross-linking compound in a weight ratio of about 10:1 to about 199:1. More suitably, the cross-linkable soy protein composition comprises an amount of soy protein product to cross-linking compound in a weight ratio of about 10:1 to about 50:1, and even more suitably, from about 19:1 to about 40:1.

Without being bound to a particular theory, it is believed that when subjected to heat and moisture, the cross-linking compound is capable of reacting with the proteins in the soy protein product, and cross-linking the proteins through a Schiff base reaction. By way of example, malonaldehyde can crosslink proteins through a Schiff base reaction with the ε-NH₂ groups of two lysine residues:

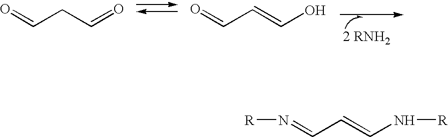

As shown above, during cross-linking, the protein radicals combine with each other, resulting in the formation of a protein network. By forming a protein network in the soy protein product, the cross-linked soy protein composition has a firmer texture when used in foods such as emulsified meat products.

As noted above, once the cross-linkable soy protein compositions are cross-linked, the cross-linked soy protein compositions have improved functionality. In one embodiment, the cross-linked soy protein compositions prepared from the cross-linkable soy protein compositions of the present disclosure have improved cooked gel strength. Having improved cooked gel strength will provide for a food product with improved texture and bite. “Cooked gel strength” as used herein is a measure of the strength of a gel of a soy protein-containing material following heating the material in boiling water for 30 minutes and then allowing the material to cool for 30 minutes under (27±5)° C. tap water. One suitable method for measuring the cooked gel strength of the cross-linked soy protein composition includes: chopping 1925 grams tap water and 385±0.1 grams cross-linked soy protein composition in a chopper bowl for 2 minutes to form a gel; removing 1155±5 grams of gel and filling four separate cans about ½ to about ¾ full of gel; to the remaining gel in the chopper bowl, resume chopping and add 23.1 grams of salt; filling four cans about ½ to about ¾ full with gel containing salt; tapping all eight cans on a hard surface to compress the gels. Once the gels are prepared, place 4 cans (2 with salt and 2 without salt) in a kettle containing rapidly boiling water and heat for 30 minutes. Immediately after heating is completed, remove the cans and allow them to cool for 30 minutes under (27±5)° C. tap water. After cooling, place the cans in refrigerated storage for 16-24 hours. The cooked gel strength of the cross-linked soy protein composition-containing gels is then measured using a TA.TXT2 Texture Analyzer, manufactured by Stable Micro Systems Ltd. (England).

Typically, cooked gel strength is evaluated in terms of grams, specifically, as the amount of force in grams required to break the gel by the plunger of the TA.TXT2 Texture Analyzer. In one embodiment, cooked gel strength is measured in an environment with 2% (by weight) salt. It is advantageous to have improved cooked gel strength in an environment comprising salt as commercially available processed meats and emulsified meat products comprising the cross-linked soy protein compositions comprise various amounts of salt.

When the soy protein product is a soy protein isolate, the cooked gel strength of the cross-linked soy protein composition measured in an environment with 2% (by weight) salt has a value of at least about 150 grams, more suitably of at least about 170 grams, even more suitably of at least about 180 grams, and even more suitably of at least about 190 grams, depending on the amount of cross-linking compound present in the cross-linkable soy protein. When the soy protein product is a soy protein concentrate, the cooked gel strength of the cross-linked soy protein composition measured in an environment with 2% (by weight) salt has a value of at least about 165 grams, more suitably of at least about 170 grams, even more suitably of at least about 180 grams, and even more suitably of at least about 190 grams, depending on the amount of cross-linking compound present in the cross-linkable soy protein.

As noted above, the present disclosure is also directed to cooked, emulsified meat products including the cross-linkable soy protein compositions prepared as described above. Specifically, processed meats can be treated with the cross-linkable soy protein compositions to form cooked emulsified meat products having improved functionality. As used herein, the term “cooked emulsified meat product” refers to processed meats, wherein their ingredients have been mixed and/or injected with the cross-linkable soy protein compositions and then steam cooked to cross-link the proteins of the cross-linkable soy protein composition to form the cross-linked soy protein composition. Additionally, the cross-linking compound of the cross-linkable soy protein can interact with, and cross-link, the proteins of the collagen-containing compound that can be found in the processed meat as described more fully below.

Processed meats that can be treated with the cross-linked soy protein compositions of the present disclosure can include, for example, hot dogs, sausages, bologna, ground meats, minced meats, meat patties, and the like, and combinations thereof. In one embodiment, the processed meat to be treated with the cross-linked soy protein composition of the present disclosure is a hot dog. In this embodiment, once the cross-linkable soy protein composition is prepared, the composition is mixed in along with the other ingredients of the hot dog such as pork, chicken, spices, etc. The mixture is filled into a cellulose casing and then steam cooked at a temperature of 180° F. (82° C.) to induce cross-linking and to form a cooked emulsified meat product.

As noted above, the processed meat can further include a collagen-containing compound. Typically, collagen-containing compounds can be formed from animal-derived collagen, such as from the corium layer of split beef hides. Suitable collagen-containing compounds found in processed meats and suitable for use in the cooked emulsified meat products can include, for example, pork skin, chicken skin, connective tissue, tendons, and combinations thereof.

Suitably, the processed meats comprise from about 2.5% (by weight) to about 8.0% (by weight) collagen-containing compound. More suitably, the processed meats comprise from about 2.5% (by weight) to about 7.5% (by weight) collagen-containing compound, and even more suitably about 5.0% (by weight) collagen-containing compound.

In addition to the cooked emulsified meat products, the present disclosure is also directed to processes of producing the cooked emulsified meat products. In one embodiment, the process for producing a cooked emulsified meat product comprises a number of steps including: (1) providing a soy protein product; (2) mixing the soy protein product with a cross-linking compound, wherein the cross-linking compound comprises at least about 10% (by total mass cross-linking compound) aldehyde to form a cross-linkable soy protein composition; (3) mixing the cross-linkable soy protein composition with a processed meat; and (4) steam cooking the mixture of cross-linkable soy protein composition and processed meat.

The soy protein product can be selected from soy protein isolates and soy protein concentrates. The soy protein isolates and soy protein concentrates can be provided as described above. Alternatively, commercially available soy protein isolates and soy protein concentrates can be provided. Suitable commercially available soy protein isolates for use in the process of the present disclosure include SUPRO® 500E and SUPRO® EX32, both available from The Solae Company (St. Louis, Mo.), and Profam® 974, available from Archer Daniels Midland Company (Decatur, Ill.). Suitable commercially available soy protein concentrates for use in the process of the present disclosure include Alpha® 12, available from The Solae Company (St. Louis, Mo.), and Arcon® S, available from Archer Daniels Midland Company (Decatur, Ill.).

Suitably, the soy protein product is provided in an amount of from about 90% (by weight cross-linkable soy protein composition) to about 99.5% (by weight cross-linkable soy protein composition). More suitably, the soy protein product is provided in an amount of from about 90% (by weight cross-linkable soy protein composition) to about 98% (by weight cross-linkable soy protein composition), and even more suitably, from about 95% (by weight cross-linkable soy protein composition) to about 97.5% (by weight cross-linkable soy protein composition).

Once the soy protein product is provided, the soy protein product is mixed with a cross-linking compound. Suitably, the soy protein product is mixed with a cross-linking compound by mixing the soy protein product and the cross-linking compound in a mixer, such as a Hobart® D300 mixer, available from Hobart Corporation (Troy, Ohio). Suitably, the soy protein product is mixed with the cross-linking compound at a speed of from about 35 revolutions per minute (rpm) to about 80 rpm for a period of about 5 minutes to about 10 minutes.

Suitable cross-linking compounds for use in the processes of the present disclosure can include, smoke flavor compounds, in powdered form, prepared as described above. Alternatively, commercially available smoke flavor compounds can be used in the processes of the present disclosure. Suitable commercially available smoke flavor compounds can include, for example, Maillose Dry, and VSA Diy, both available from Red Arrow International LLC, Manitowoc, Wis.

As stated above, the cross-linking compound has at least about 10% (by total mass cross-linking compound) aldehyde. More suitably, the cross-linking compound for use in the processes of the present disclosure comprises from about 10% (by total mass cross-linking compound) to about 20% (by total mass cross-linking compound) aldehyde, and even more suitably, from about 10% (by total mass cross-linking compound) to about 12% (by total mass cross-linking compound) aldehyde.

Suitably, the soy protein product is mixed with a cross-linking compound in a weight ratio of soy protein product to cross-linking compound of from about 10:1 to about 199:1. More suitably, the soy protein product is mixed with a cross-linking compound in a weight ratio of soy protein product to cross-linking compound of from about 10:1 to about 50:1, even more suitably from about 19:1 to about 40:1.

Once the cross-linkable soy protein composition is prepared, the cross-linkable soy protein composition is mixed with a processed meat. As noted above, suitable processed meats for use in producing the emulsified meat products of the present disclosure include hot dogs, sausages, bologna, ground meats, minced meats, and the like, and combinations thereof. Typically, the cross-linkable soy protein composition is chopped or mixed with the other ingredients of the processed meat using a bowl chopper, such as a Maicor, Model CR-40, available from Mid Atlantic Equipment, Spain. For example, in one embodiment, the processed meat is a hot dog and the cross-linkable soy protein composition is mixed with the other ingredients of the hot dog including pork, chicken, spices, salt, starch, Prague powder containing 6.25% (by weight) nitrite, sodium tripolyphosphate, sodium erythorbate, and dextrose in a bowl chopper, chopping at a speed of about 3400 rpm for a period of from about 4 to about 6 minutes. In another embodiment, the cross-linkable soy protein composition is mixed with the other ingredients of the hot dog using a mixer, such as a twin agitator mixer, mixing at a speed of about 24 rpm for a period of from about 10 minutes to about 20 minutes.

After mixing/chopping the cross-linkable soy protein composition and the processed meat, the mixture is heat and moisture treated causing the cross-linking compound to interact with and to cross-link the soy proteins of the cross-linkable soy protein composition to form the cooked emulsified meat product including a cross-linked soy protein composition. Additionally, in the embodiments where the processed meat comprises a collagen-containing compound, the cross-linking compound can interact with and cross-link the proteins of the collagen-containing compound. Similar to the soy proteins of the cross-linkable soy protein compositions, the proteins of the collagen-containing compound can cross-link and form a collagen-containing network, which can further improve texture and bite of the cooked emulsified meat product.

In one embodiment, the mixture of cross-linkable soy protein composition and processed meat is heat and moisture treated by steam cooking the mixture at a temperature of about 180° F. (82° C.) for a period of about 20 minutes or until the internal temperature reaches about 161.6° F. (72° C.).

Generally, the cooked emulsified meat products including the cross-linked soy protein compositions manufactured in accordance with the present process exhibit improved hardness and chewiness when compared to untreated meat products. Without being bound to a particular theory, it is believed that the cooked emulsified meat products have improved functionality as a result of the protein network produced by the cross-linking of the proteins in the soy protein product of the cross-linkable soy protein compositions as well as the proteins in the collagen-containing compounds of the processed meats as described above. This allows for a cooked emulsified meat product having improved hardness and chewiness. Hardness and chewiness are expressed in terms of grams and may be determined using a TA.TXT2 Texture Analyzer, manufactured by Stable Micro Systems, Ltd. (England).

In one embodiment, the hardness and chewiness are measured as “hot hardness” and “hot chewiness”, which is a measurement taken after heating the cooked emulsified meat product in boiling water for 5 to 7 minutes or until the internal temperature of the emulsified meat product reaches 160° F. (71° C.). In another embodiment, the hardness and chewiness are measured as “room temperature” hardness and chewiness, which are measurements taken of the cooked emulsified meat product after the temperature of the cooked emulsified meat product reaches room temperature (i.e., about 77° F. (25° C.)). To lower the temperature of the cooked emulsified meat product to room temperature, the cooked emulsified meat product can suitably be stored at room temperature for a period of from about 12 hours to about 24 hours. Once the hardness and chewiness measurements have been taken, average hardness and average chewiness values are determined.

When the soy protein product is a soy protein isolate, improvements in average hardness of the cooked emulsified meat products of from about 20.9% to about 44.6% have been observed. When the soy protein product is a soy protein concentrate, improvements in average hardness of the cooked emulsified meat products of from about 3.0% to about 14.1% have been observed.

When the soy protein product is a soy protein isolate, improvements in average chewiness of the cooked emulsified meat products of from about 16% to about 34.7% have been observed. When the soy protein product is a soy protein concentrate, improvements in average chewiness of the cooked emulsified meat products of about 4.9% have been observed.

The following examples are simply intended to further illustrate and explain the present disclosure. The disclosure, therefore, should not be limited to any of the details in these examples.

### EXAMPLE 1

In this Example, hot dogs treated with a cross-linkable soy protein composition are prepared and the room temperature hardness, room temperature chewiness, hot hardness, and hot chewiness of the hot dogs are evaluated.

To produce the cross-linkable soy protein compositions for inclusion in the hot dog, various amounts of SUPRO® 500E, which is a soy protein isolate available from The Solae Company (St. Louis, Mo.), are mixed with various amounts of VSA Dry, a powdered smoke flavor compound available from Red Arrow International LLC (Manitowoc, Wis.) and having 10% (by total mass smoke flavor compound) aldehyde. The SUPRO® 500E and VSA Dry are mixed using a Hobart mixer, available from Hobart Corporation (Troy, Ohio), mixing at a speed of 50 revolutions per minute (rpm) for 5 minutes. Specifically, three different samples of cross-linkable soy protein composition comprising three different amounts of SUPRO® 500E and VSA Dry are produced. The three different samples and their compositions are shown in Table 1:

TABLE 1

| Sample | SUPRO ® 500E (grams) | Smoke flavor compound (grams) |
|---|---|---|
| A | 1000 | 0 |
| B | 975 | 25 |
| C | 950 | 50 |

Once cross-linkable soy protein composition samples A, B, and C are prepared, three samples, A′, B′, and C′, of cooked emulsified meat product comprising hot dogs treated with samples A, B, and C, respectively are obtained. The three cooked emulsified meat product samples comprising 4% (by weight) cross-linkable soy protein composition are produced by first adding 918 grams of pre-break frozen pork backfat (5/95) particles (12 millimeters in size) (commercially available from Weyhaupt Bros., Belleville, Ill.) to 200 grams of cross-linkable soy protein composition sample in a bowl chopper (commercially available as Robot Coupe, Robot Coupe U.S.A., Inc., Jackson, Mass.), followed by adding the other ingredients, which include: 705 grams deboned ham (95/5) (available from 1BP, Dakota Dunes, S. Dak.), 500 grains pork rind emulsion (made by mixing 1 part pork rind (available from Middendoff, St. Louis, Mo.) with 1 part tap water in an emulsifier (Mince Master, The Griffith Laboratories Co., Chicago, Ill.)), and 1000 grams chicken mechanical deboned meat (available from Townsends of Arkansas, Inc., Batesville, Ark.), into the bowl chopper. These meat ingredients are chilled to a temperature of from about 0° C. to about 4° C. prior to being added to the bowl chopper. Dry ingredients, including: 85 grains salt, 100 grains potato starch (available from Avebe, Veendam, Holland), 16 grams Praque powder containing 6.25% (by weight) nitrite (available from Newly Weds, Chicago, Ill.), 15 grams sodium tripolyphosphate (available from Astaris, St. Louis, Mo.), 3 grams sodium erythorbate (available from Spicetec, Ltd., Carol Stream, Ill.), 13 grams dextrose, 15 grams spice mixture (mixture of white pepper powder, nutmeg powder, garlic powder, and ginger powder, all available from Pocahontas, Richmond, Va.), and 1433 grams ice/water mixture (0° C.), are also then added to the bowl chopper to form a meat batter. Chopping of the meat batter is then conducted at a speed of 3400 rpm for 4 minutes. The meat batter is then stuffed into a 22-millimeter diameter cellulose casing (available from Viskase, Chicago, Ill.) and steam cooked in a smokehouse until the internal temperature of the meat batter reaches 72° C. to form the cooked emulsified meat product. As noted above, this steam cooking process induces cross-linking of the proteins in the cross-linkable soy protein composition, to form the cross-linked soy protein composition. The cooked emulsified meat product is then placed in an ice/water shower (5° C.) to cool down and the cellulose casing is peeled from the cooked emulsified meat product.

The room temperature hardness, room temperature chewiness, hot hardness, and hot chewiness of samples A′, B′, and C′ are then evaluated using the methods discussed herein above. The average force is then determined by averaging the results of room temperature hardness, room temperature chewiness, hot hardness, and hot chewiness. The results of the evaluations are shown in Table 2:

TABLE 2

| | Room | Room | Hot | Hot | Average |
|---|---|---|---|---|---|
| | Temperature | Temperature | Hardness | Chewiness | Force |
| Sample | Hardness (g) | Chewiness (g) | (g) | (g) | (g) |
| A′ | 9482 | 1147 | 5539 | 937 | 4276 |
| B′ | 12688 | 1487 | 7507 | 1250 | 5733 |
| C′ | 13358 | 1534 | 8368 | 1274 | 6133 |

Three additional samples, A″, B″, and C″ (corresponding to above samples A, B, and C, respectively) of cooked emulsified meat product samples comprising 5% (by weight) cross-linkable soy protein composition are produced by first adding 918 grams of pre-break frozen pork backfat (5/95) particles (12 millimeters in size) (commercially available from Weyhaupt Bros., Belleville, Ill.) to 250 grams of cross-linkable soy protein composition sample in a bowl chopper (commercially available as Robot Coupe, Robot Coupe U.S.A., Inc., Jackson, Mass.), followed by adding the other ingredients, which include: 505 grams deboned ham (95/5) (available from 1BP, Dakota Dunes, S. Dak.), 750 grams pork rind emulsion (made by mixing 1 part pork rind (available from Middendoff, St. Louis, Mo.) with 1 part tap water in an emulsifier (Mince Master, The Griffith Laboratories Co., Chicago, Ill.)), and 900 grams chicken mechanical deboned meat (available from Townsends of Arkansas, Inc., Batesville, Ark.), are then added into the bowl chopper. These meat ingredients are chilled to a temperature of from about 0° C. to about 4° C. prior to being added to the bowl chopper. Dry ingredients, including: 85 grams salt, 100 grams potato starch (available from Avebe, Veendam, Holland), 16 grams Praque powder containing 6.25% (by weight) nitrite (available from Newly Weds, Chicago, Ill.), 15 grams sodium tripolyphosphate (available from Astaris, St. Louis, Mo.), 3 grams sodium erythorbate (available from Spicetec, Ltd., Carol Stream, Ill.), 13 grams dextrose, 15 grams spice mixture (mixture of white pepper powder, nutmeg powder, garlic powder, and ginger powder, all available from Pocahontas, Richmond, Va.), and 1433 grams ice/water mixture (0° C.), are also then added to the bowl chopper to form a meat batter. Chopping of the meat batter is then conducted at a speed of 3400 rpm for 4 minutes. The meat batter is then stuffed into a 22-millimeter diameter cellulose casing (available from Viskase, Chicago, Ill.) and steam cooked in a smokehouse until the internal temperature of the meat batter reaches 72° C. to form the cooked emulsified meat product. The cooked emulsified meat product is then placed in an ice/water shower (5° C.) to cool down and the cellulose casing is peeled from the cooked emulsified meat product.

The room temperature hardness, room temperature chewiness, hot hardness, and hot chewiness of samples A″, B″, and C″ are then evaluated using the methods discussed herein above. The average force is then determined by averaging the results of room temperature hardness, room temperature chewiness, hot hardness, and hot chewiness. The results of the evaluations are shown in Table 3:

TABLE 3

| | Room | Room | Hot | Hot | Average |
|---|---|---|---|---|---|
| | Temperature | Temperature | Hardness | Chewiness | Force |
| Sample | Hardness (g) | Chewiness (g) | (g) | (g) | (g) |
| A″ | 12576 | 1461 | 6208 | 913 | 5289 |
| B″ | 12967 | 1422 | 6566 | 976 | 5483 |
| C″ | 13191 | 1486 | 7486 | 968 | 5783 |

As shown in Tables 2 and 3, as the amount of smoke flavor compound (i.e., cross-linking compound) in the cross-linkable soy protein composition is increased, the room temperature hardness and hot hardness values of the hot dogs including the cross-linked soy protein compositions (at both 4% (by weight) and 5% (by weight) concentrations) prepared from the cross-linkable soy protein compositions are increased. Specifically, the room temperature hardness values increase by as much as about 33.8% when 25 grains smoke flavor compound is added to the cross-linkable soy protein composition and increase by as much as about 40.9% when 50 grains smoke flavor compound is added. The hot hardness values increase by as much as about 35.5% when 25 grams smoke flavor compound is added to the cross-linkable soy protein composition and increase by as much as about 51.1% when 50 grams smoke flavor compound is added. Similarly, when the hot dog comprises a cross-linked soy protein composition prepared from a cross-linkable soy protein composition including a smoke flavor compound, the room temperature chewiness and hot chewiness values generally increase. As such, Tables 2 and 3 show that the addition of smoke flavor compound to the cross-linkable soy protein composition provides a firmer hot dog texture.

### EXAMPLE 2

In this Example, hot dogs, including chicken skin as a collagen-containing compound and treated with a cross-linkable soy protein composition, are prepared and the room temperature hardness, room temperature chewiness, hot hardness, and hot chewiness of the hot dogs are evaluated.

Three samples (A, B, and C) of cross-linkable soy protein compositions are produced as in Example 1.

Once samples A, B, and C are prepared, three samples, A′, B′, and C′, of cooked emulsified meat product comprising hot dogs treated with samples A, B, and C, respectively are obtained. The three cooked emulsified meat product samples comprising 4% (by weight) cross-linkable soy protein composition are produced by chopping 200 grams of cross-linkable soy protein composition sample with the processed meat ingredients, which include: 705 grams chicken breast meat (available from Middendoff, St. Louis, Mo.), 500 grams chicken skin (available from Townsends of Arkansas, Inc., Batesville, Ark.), and 1500 grams chicken mechanical deboned meat (available from Townsends of Arkansas, Inc., Batesville, Ark.). These meat ingredients are chilled to a temperature of from about 0° C. to about 4° C. prior to being added to the bowl chopper. Dry ingredients, including: 60 grams salt, 250 grams potato starch (available from Avebe, Veendam, Holland), 16 grams Praque powder containing 6.25% (by weight) nitrite (available from Newly Weds, Chicago, Ill.), 15 grams sodium tripolyphosphate (available from Astaris, St. Louis, Mo.), 3 grams sodium erythorbate (available from Spicetec, Ltd., Carol Stream, Ill.), 13 grams dextrose, I gram spice mixture (AMI spices, available from Kalsec, Kalamazoo, Mich.), and 1606 grams ice/water mixture (0° C.), are also then added to the bowl chopper to form a meat batter. Chopping of the meat batter is then conducted at a speed of 3400 rpm for 4 minutes. The meat batter is then stuffed into a 22-millimeter diameter cellulose casing (available from Viskase, Chicago, Ill.) and steam cooked in a smokehouse until the internal temperature of the meat batter reaches 72° C. to form the cooked emulsified meat product. As noted above, this steam cooking process induces cross-linking of the proteins in the cross-linkable soy protein composition, to form the cross-linked soy protein composition. The cooked emulsified meat product is then placed in an ice/water shower (5° C.) to cool down and the cellulose casing is peeled from the cooked emulsified meat product.

The room temperature hardness, room temperature chewiness, hot hardness, and hot chewiness of samples A′, B′, and C′ are then evaluated using the methods discussed herein above. The average force is then determined by averaging the results of room temperature hardness, room temperature chewiness, hot hardness, and hot chewiness. The results of the evaluations are shown in Table 4:

TABLE 4

| | Room | Room | Hot | Hot | Average |
|---|---|---|---|---|---|
| | Temperature | Temperature | Hardness | Chewiness | Force |
| Sample | Hardness (g) | Chewiness (g) | (g) | (g) | (g) |
| A′ | 6877 | 1174 | 5198 | 1002 | 3563 |
| B′ | 7429 | 1333 | 5744 | 1075 | 3895 |
| C′ | 8177 | 1428 | 6417 | 1097 | 4280 |

As shown in Table 4, as the amount of smoke flavor compound (i.e., cross-linking compound) in the cross-linkable soy protein composition is increased, the room temperature hardness and hot hardness values of the hot dogs including the cross-linked soy protein compositions prepared from the cross-linkable soy protein compositions are increased. Specifically, the room temperature hardness values increase by as much as about 18.9% when 50 grams smoke flavor compound is added to the cross-linkable soy protein composition. The hot hardness values increase by as much as about 23.5% when 50 grams smoke flavor compound is added to the cross-linkable soy protein composition. Similarly, when the hot dog comprises a cross-linked soy protein composition prepared from a cross-linkable soy protein composition including a smoke flavor compound, the room temperature chewiness and hot chewiness values generally increase. As such, Table 4 shows that the addition of smoke flavor compound to the cross-linkable soy protein composition provides a firmer hot dog texture.

### EXAMPLE 3

In this Example, hot dogs including chicken skin as a collagen-containing compound and treated with a cross-linkable soy protein composition are prepared and the room temperature hardness, room temperature chewiness, hot hardness, and hot chewiness of the hot dogs are evaluated.

Three samples (A, B, and C) of cross-linkable soy protein compositions are produced as in Example 1 except that the soy protein product SUPRO® 500E is replaced by Alpha® 12, a commercially available soy protein concentrate (The Solae Company, St. Louis, Mo.).

Once samples A, B, and C are prepared, three samples, A′, B′, and C′, of cooked emulsified meat product comprising hot dogs treated with samples A, B, and C, respectively are obtained. The three cooked emulsified meat product samples comprising 4% (by weight) cross-linkable soy protein composition are produced by chopping 200 grams of cross-linkable soy protein composition sample with the processed meat ingredients, which include: 705 grams chicken breast meat (available from Middendoff, St. Louis, Mo.), 500 grams chicken skin (available from Townsends of Arkansas, Inc., Batesville, Ark.), and 1500 grams chicken mechanical deboned meat (available from Townsends of Arkansas, Inc., Batesville, Ark.). These meat ingredients are chilled to a temperature of from about 0° C. to about 4° C. prior to being added to the bowl chopper. Dry ingredients, including: 60 grams salt, 250 grams potato starch (available from Avebe, Veendam, Holland), 16 grams Praque powder containing 6.25% (by weight) nitrite (available from Newly Weds, Chicago, Ill.), 15 grams sodium tripolyphosphate (available from Astaris, St. Louis, Mo.), 3 grams sodium erythorbate (available from Spicetec, Ltd., Carol Stream, Ill.), 13 grams dextrose, 1 gram spice mixture (AMI spices, available from Kalsec, Kalamazoo, Mich.), and 1606 grams ice/water mixture (0° C.), are also then added to the bowl chopper to form a meat batter. Chopping of the meat batter is then conducted at a speed of 3400 rpm for 4 minutes. The meat batter is then stuffed into a 22-millimeter diameter cellulose casing (available from Viskase, Chicago, Ill.) and steam cooked in a smokehouse until the internal temperature of the meat batter reaches 72° C. to form the cooked emulsified meat product. As noted above, this steam cooking process induces cross-linking of the proteins in the cross-linkable soy protein composition, to form the cross-linked soy protein composition. The cooked emulsified meat product is then placed in an ice/water shower (5° C.) to cool down and the cellulose casing is peeled from the cooked emulsified meat product.

The room temperature hardness, room temperature chewiness, hot hardness, and hot chewiness of samples A′, B′, and C′ are then evaluated using the methods discussed herein above. The average force is then determined by averaging the results of room temperature hardness, room temperature chewiness, hot hardness, and hot chewiness. The results of the evaluations are shown in Table 5:

TABLE 5

| | Room | Room | Hot | Hot | Average |
|---|---|---|---|---|---|
| | Temperature | Temperature | Hardness | Chewiness | Force |
| Sample | Hardness (g) | Chewiness (g) | (g) | (g) | (g) |
| A′ | 7069 | 1255 | 5547 | 1037 | 3727 |
| B′ | 6628 | 1219 | 5265 | 975 | 3522 |
| C′ | 8010 | 1334 | 6386 | 1070 | 4200 |

As shown in Table 5, as the amount of smoke flavor compound (i.e., cross-linking compound) in the cross-linkable soy protein composition is increased, the room temperature hardness and hot hardness values of the hot dogs including the cross-linked soy protein compositions prepared from the cross-linkable soy protein compositions are increased. Specifically, the room temperature hardness values increase by as much as about 13.31% when 50 grams smoke flavor compound is added to the cross-linkable soy protein composition. The hot hardness values increase by as much as about 15.13% when 50 grams smoke flavor compound is added to the cross-linkable soy protein composition. Similarly, when the hot dog comprises a cross-linked soy protein composition prepared from a cross-linkable soy protein composition including a smoke flavor compound, the room temperature chewiness and hot chewiness values generally increase. As such, Table 5 shows that the addition of smoke powder composition to the cross-linkable soy protein composition provides a firmer hot dog texture.

### EXAMPLE 4

In this Example, hot dogs treated with a cross-linkable soy protein composition are prepared and the room temperature hardness, room temperature chewiness, hot hardness, and hot chewiness of the hot dogs are evaluated.

Three samples (A, B, and C) of cross-linkable soy protein compositions for cross-linking to form the cross-linked soy protein compositions are produced as in Example 1.

Once samples A, B, and C are prepared, three samples, A′, B′, and C′, of cooked emulsified meat product comprising hot dogs treated with samples A, B, and C, respectively are obtained. The three cooked emulsified meat product samples comprising 4% (by weight) cross-linkable soy protein composition are produced by first chopping 200 grams of cross-linkable soy protein composition sample with 3000 grams chicken mechanical deboned meat (available from Townsends of Arkansas, Inc., Batesville, Ark.). The chicken mechanical deboned meat is chilled to a temperature of from about 0° C. to about 4° C. prior to being added to the bowl chopper. Dry ingredients, including: 85 grams salt, 300 grams corn starch (available from Tate and Lyle Ingredients Americas, Inc., Decatur, Ill.), 16 grams Praque powder containing 6.25% (by weight) nitrite (available from Newly Weds, Chicago, Ill.), 15 grams sodium tripolyphosphate (available from Astaris, St. Louis, Mo.), 3 grams sodium erythorbate (available from Spicetec, Ltd., Carol Stream, Ill.), 8 grams sodium acid pyrophosphate (available from J. M. Swank, North Liberty, Iowa), and 1374 grams ice/water mixture (0° C.), are also then added to the bowl chopper to form a meat batter. Chopping of the meat batter is then conducted at a speed of 3400 rpm for 4 minutes. The meat batter is then stuffed into a 22-millimeter diameter cellulose casing (available from Viskase, Chicago, Ill.) and steam cooked in a smokehouse until the internal temperature of the meat batter reaches 72° C. to form the cooked emulsified meat product. As noted above, this steam cooking process induces cross-linking of the proteins in the cross-linkable soy protein composition, to form the cross-linked soy protein composition. The cooked emulsified meat product is then placed in an ice/water shower (5° C.) to cool down and the cellulose casing is peeled from the cooked emulsified meat product.

The room temperature hardness, room temperature chewiness, hot hardness, and hot chewiness of samples A′, B′, and C′ are then evaluated using the methods discussed herein above. The average force is then determined by averaging the results of room temperature hardness, room temperature chewiness, hot hardness, and hot chewiness. The results of the evaluations are shown in Table 6:

TABLE 6

| | Room | Room | Hot | Hot | Average |
|---|---|---|---|---|---|
| | Temperature | Temperature | Hardness | Chewiness | Force |
| Sample | Hardness (g) | Chewiness (g) | (g) | (g) | (g) |
| A′ | 6090 | 1171 | 5634 | 1029 | 3481 |
| B′ | 8587 | 1593 | 5945 | 1178 | 4326 |
| C′ | 9141 | 1732 | 6536 | 1209 | 4654 |

As shown in Table 6, as the amount of smoke flavor compound (i.e., cross-linking compound) in the cross-linkable soy protein composition is increased, the room temperature hardness and hot hardness values of the hot dogs including the cross-linked soy protein compositions prepared from the cross-linkable soy protein compositions are increased. Specifically, the room temperature hardness values increase by as much as about 41.0% when 25 grams smoke flavor compound is added to the cross-linkable soy protein composition and increase by as much as about 50.1% when 50 grains smoke flavor compound is added. The hot hardness values increase by as much as about 5.52% when 25 grains smoke flavor compound is added to the cross-linkable soy protein composition and increase by as much as about 16.01% when 50 grams smoke flavor compound is added. Similarly, when the hot dog comprises a cross-linked soy protein composition prepared from a cross-linkable soy protein composition including a smoke powder composition, the room temperature chewiness and hot chewiness values generally increase. As such, Table 6 shows that the addition of smoke powder composition to the cross-linkable soy protein composition provides a firmer hot dog texture.

In view of the above, it will be seen that the several objects of the disclosure are achieved and other advantageous results obtained.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “by weight” is used throughout the application to describe the amounts of components in the soy protein isolates and soy protein concentrates. Unless otherwise specified, the term “by weight” is intended to mean by weight on an as is basis, without any moisture added or removed from the product. The term by weight moisture-free is intended to mean on a dry basis, in which the moisture has been removed.

As various changes could be made in the above without departing from the scope of the disclosure, it is intended that all matter contained in the above description and shown in the accompanying drawings shall be interpreted as illustrative and not in a limiting sense.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A cross-linkable soy protein composition comprising a soy protein product and a cross-linking compound, wherein the cross-linking compound comprises at least about 10% (by total mass cross-linking compound) aldehyde, wherein the cross-linkable soy protein composition is suitable for use in an emulsified meat product and wherein the soy protein product is selected from the group consisting of soy protein isolates and soy protein concentrates.

2. The cross-linkable soy protein composition as set forth in claim 1 wherein the cross-linking compound is a smoke flavor compound.

3. The cross-linkable soy protein composition as set forth in claim 1 wherein the cross-linking compound comprises from about 10% (by total mass cross-linking compound) to about 20% (by total mass cross-linking compound) aldehyde.

4. The cross-linkable soy protein composition as set forth in claim 1 comprising a weight ratio of soy protein product to cross-linking compound of from about 10:1 to about 50:1.

5. A cooked, emulsified meat product comprising a processed meat and a cross-linked soy protein composition, the cross-linked soy protein composition being prepared from a cross-linkable soy protein composition comprising a soy protein product and a cross-linking compound, wherein the cross-linking compound comprises at least about 10% (by total mass cross-linking compound) aldehyde, and
wherein the soy protein product is selected from the group consisting of soy protein isolates and soy protein concentrates.

6. The cooked, emulsified meat product as set forth in claim 5 wherein the cross-linking compound is a smoke flavor compound.

7. The cooked, emulsified meat product as set forth in claim 5 wherein the cross-linking compound comprises from about 10% (by total mass cross-linking compound) to about 20% (by total mass cross-linking compound) aldehyde.

8. The cooked, emulsified meat product as set forth in claim 5 wherein the cross-linkable soy protein composition comprises a weight ratio of soy protein product to cross-linking compound of from about 10:1 to about 50:1.

9. The cooked, emulsified meat product as set forth in claim 5 wherein the processed meat comprises a collagen-containing compound selected from the group consisting of pork skin, chicken skin, connective tissue, tendons, and combinations thereof.

10. The cooked, emulsified meat product as set forth in claim 9 wherein the processed meat comprises from about 2.5% (by weight) to about 8.0% (by weight) collagen-containing compound.

11. The cooked, emulsified meat product as set forth in claim 5 wherein the processed meat is selected from the group consisting of hot dogs, sausages, bologna, ground meats, minced meats, and combinations thereof.

12. The cooked, emulsified meat product as set forth in claim 5 wherein the emulsified meat product has a water holding capacity of from about 7.0 to about 9.0.

13. A process of producing a cooked emulsified meat product, the process comprising:
providing a soy protein product;
mixing the soy protein product with a cross-linking compound to form a cross-linkable soy protein composition, wherein the cross-linking compound comprises at least about 10% (by total mass cross-linking compound) aldehyde;
mixing the cross-linkable soy protein composition with a processed meat; and
steam cooking the mixture of cross-linkable soy protein composition and processed meat to form a cooked emulsified meat product,
wherein the soy protein product is selected from the group consisting of soy protein isolates and soy protein concentrates.

14. The process as set forth in claim 13 wherein the cross-linking compound is a smoke flavor compound.

15. The process as set forth in claim 13 wherein the cross-linking compound comprises from about 10% (by total mass cross-linking compound) to about 20% (by total mass cross-linking compound) aldehyde.

16. The process as set forth in claim 13 wherein the soy protein product and cross-linking compound are mixed in a weight ratio of soy protein product to cross-linking compound of from about 10:1 to about 50:1.

17. The process as set forth in claim 13 wherein the processed meat comprises a collagen-containing compound, selected from the group consisting of pork skin, chicken skin, connective tissue, tendons, and combinations thereof.

18. The process as set forth in claim 31 wherein the processed meat comprises from about 2.5% (by weight) to about 8.0% (by weight) collagen-containing compound.

19. The process as set forth in claim 13 wherein the processed meat is selected from the group consisting of hot dogs, sausages, bologna, ground meats, minced meats, and combinations thereof.

20. The process as set forth in claim 13 wherein the emulsified meat product has a water holding capacity of from about 7.0 to about 9.0.
